(19) United States
(12) Patent Application Publication
(10) Pub. No.: US 2025/0123507 A1
(43) Pub. Date: Apr. 17, 2025

(54) PHASE-MATCHED NONRECIPROCAL POLARIZATION ROTATING WAVEGUIDE DEVICE AND OPTICAL ISOLATOR/OPTICAL CIRCULATOR USING THEREOF

(71) Applicant: PhotoniSol Inc., Incheon (KR)

(72) Inventors: Kyong Hon KIM, Incheon (KR); Seung Hwan KIM, Incheon (KR); Beom Su PARK, Incheon (KR)

(21) Appl. No.: 18/884,752

(22) Filed: Sep. 13, 2024

(30) Foreign Application Priority Data
Oct. 11, 2023 (KR) 10-2023-0134870

(51) Int. Cl. G02F 1/095

(52) U.S. Cl. CPC G02F 1/0955

(57) ABSTRACT

A phase-matched non-reciprocal polarization rotation optical waveguide device is designed for integrated optical isolator and optical circulator applications by eliminating the birefringent characteristics by optimizing the optical waveguide structures. The optimized optical waveguide device structure satisfies phase-matching conditions between two orthogonal polarization-mode beams during the propagation along the waveguide to have an efficient polarization rotation. Contrary to the conventional scheme having a drawback of long device length, the invented optical waveguide devices made of semiconductor or dielectric material provide the phase-matching condition with a continuous magneto-optic clad layer and thus allow a short device length suitable to integration with other waveguide devices.

### CROSS-REFERENCE TO RELATED APPLICATIONS

This application claims the priority to Korean Patent Application No. 10-2023-0134870, filed with the Korean Intellectual Property Office on Oct. 11, 2023, the disclosure of which is incorporated herein by reference in its entirety.

### BACKGROUND

### 1. Technical Field

The present invention describes phase-matched nonreciprocal polarization rotation waveguide devices for integrated optical isolators and circulators. The device schemes provide phase-matched conditions between two orthogonal polarizations to induce an efficient polarization rotation during the optical beam propagation along the waveguide. Then, the waveguide device length can be shortened to be more suitable for integration with other semiconductor optical waveguide devices by having a magneto-optic (MO) film clad of the entire device length and by having optimum waveguide structures eliminating the birefringent-induced phase mismatch.

### 2. Description of the Related Art

Recently, rapid increases in data and information processing capacities have required photonic integrated modules and circuit technologies, such as optical interposers and optical interconnects, for applications to large-capacity optical transceiver modules in data centers and to signal I/O processes between electronic chips. For the photonic integrated modules and circuits, the integrated optical isolator chip is one of the critical components. Two approaches, one with polarization mode conversion and the other with phase shift, based on the Faraday effect in magneto-optic thin films, have been investigated to demonstrate the optical isolator chips.

The nonreciprocal polarization mode conversion (NRPMV) scheme and nonreciprocal phase shift (NRPS) scheme utilizing the magneto-optic effect are used to demonstrate the optical isolator chips. Experimental demonstration of the optical isolator chips based on the nonreciprocal polarization mode conversion scheme is complex because the polarization mode conversion process is sensitive to phase mismatches between TE and TM polarization modes. On the other hand, the experimental demonstration of the optical isolator chips based on the nonreciprocal phase shift scheme is relatively easy since this method uses mainly the phase shift in optical interferometers. However, the optical isolators with the NRPS scheme have the disadvantage of a relatively narrow wavelength range of optical isolation. The NRPMV scheme has the advantage of relatively easy demonstration of optical isolation over a broad wavelength region. Some researchers have researched device schemes satisfying the phase-matching conditions to compensate for the phase mismatch between TE and TM polarization modes in the NRPMV scheme.

U.S. Pat. Nos. 4,671,621, 4,886,332, and 4,859,013 and published papers [Appl. Phys. Lett. 21(8), 394 (1972), IEEE Tr. on Magnetics 21(5), 1647 (1985), IEEE Tr. on Microwave Theory & Techniques 33(2), 149 (1985), Appl. Phys. Lett. 56(5), 426 (1990), Appl. Phys. Lett. 49(26), 1755 (1986), Opt. Commun. 158, 189 (1998)] report on various phase-matching methods, such as a first method utilizing the magneto-optic film as an optical waveguide medium and compensating the linear birefringence with periodically opposite directions of magnetization of the MO film to satisfy the phase-matching condition, a second method having thermal treatment or open MO film structures to eliminate any stress imposed on the MO films, a third method forming optical non-isotropic structures of the MO film itself or its side, and a fourth method forming sinusoidal electrode patterns on the MO films to induce magnetic fields of periodically opposite directions during a current flow along the electrode. However, these methods have drawbacks in integration with other optical waveguide devices made of silicon or semiconductor materials because they use the MO film as a waveguide core material.

Recently optical waveguide devices of the nonreciprocal polarization rotation based on silicon or semiconductor core waveguides with the MO film upper clad have been reported. Patents US 20220214568 and WO 2021/076627 and published papers [IEEE Photon. J. 3(3), 450 (2011) and ACS Photonics 6, 2455 (2019)] describe a device scheme to enhance the polarization rotation properties based on the Faraday effect using a phase-matching condition in optical waveguide structures of periodically formed MO film and non-magneto-optic film clad layers. This scheme has the drawback of a long waveguide length requirement for the nonreciprocal polarization rotation due to the periodic formation of the non-magneto-optic film clads.

### Patent Document

Korean registered patent 10-1550502 (2015.09.04 published) “INTEGRATABLE PLANAR WAVEGUIDE-TYPE OPTICAL ISOLATOR AND CIRCULATOR WITH POLARIZATION-MODE CONTROL”

In the preceding <Patent document>, a nonreciprocal polarization rotator scheme and an optical isolator and circulator chip scheme were reported, but no phase-matching condition was presented.

### SUMMARY OF THE INVENTION

The present invention was devised to solve the above problems.

The purpose of the present invention is to provide a waveguide device scheme of semiconductor or dielectric optical waveguides with magneto-optic material clads for phase-matched nonreciprocal polarization-rotation condition which lets an efficient phase matching take place between the two orthogonal polarization beams propagating along the waveguide and thus allows shortening of the device length and easy integration with other semiconductor devices ultimately.

Another purpose of the present invention is to provide a waveguide device scheme that uses a continuous device-long magneto-optic clad over semiconductor or dielectric optical waveguides to solve the long device requirement of the conventional phase-matched nonreciprocal polarization-rotation waveguide devices formed with semiconductor optical waveguide structures of periodically formed MO film and non-magneto-optic film clad layers. Thus, the device length can be shortened.

Another purpose of the present invention is to optimize the optical waveguide structure itself so that a phase-matched nonreciprocal polarization-rotation optical waveguide device can be achieved by eliminating birefringence properties.

Another purpose of the present invention is to provide the optical isolator and circulator devices by using the phase-matched nonreciprocal polarization rotation optical waveguide device, which can be used for photonic integrated devices needed in high-capacity optical transceiver modules of data center and optical communications applications and for optical interposers and interconnects between electronic chips to demonstrate next-generation semiconductors and high-performance computers.

The present invention can be implemented in exemplary embodiments with the following configurations to achieve the above-described object.

According to an embodiment of the present invention, a phase-matched nonreciprocal polarization rotation waveguide device is provided. The device includes an optical waveguide of relatively high refractive index material to guide optical signals, cladding layers surrounding the optical waveguide, one side or two sides of the cladding layer of the optical waveguide composed of a magneto-optic film of relatively lower refractive index, and the width of the optical waveguide determined for a condition of the same effective index of the TE and TM polarization modes at the optical signal wavelength.

According to another embodiment of the present invention, the above-mentioned optical waveguide consists of consecutively periodic arrangements of broader and narrower waveguide widths than the optical waveguide width of the same effective index condition of the TE and TM polarization modes at the optical signal wavelength.

According to another embodiment of the present invention, the above-mentioned optical waveguide can be formed to have a waveguide cross-section of rectangular shape called a strip waveguide.

According to another embodiment of the present invention, the above-mentioned optical waveguide can be formed to have a waveguide cross-section of a wider lower portion than the upper portion in a rib waveguide shape.

According to another embodiment of the present invention, the above-mentioned optical waveguide can be formed to have a waveguide cross-section with an internal trench in its central region.

According to another embodiment of the present invention, the phase-matched nonreciprocal polarization rotation waveguide devices mentioned above can have an additional buffer layer between the optical waveguide and the magneto-optic film to enhance the crystallization processes of the MO film.

According to another embodiment of the present invention, optical isolators, and optical circulators using those mentioned above phase-matched nonreciprocal polarization rotation (PMNPR) waveguide devices include a pair of polarization beam splitters (PBSs) at the input and output terminals at both ends, a PMNPR waveguide device having a length suitable to rotate the signal's polarization to 45 degrees, an optical waveguide device for 45-degree reciprocal polarization rotation, and have a configuration of the PMNPR waveguide device mentioned above and reciprocal polarization rotation waveguide device placed on each of the two optical waveguide paths connecting the above two PBSs. An input optical signal entering an input port of the PBS located at the input side propagates through the output port of the other side PBS. A reflected optical signal returning to the output port of the other side PBS propagates through the other port of the input side PBS.

The present invention provides the following effects from the configuration, combination, and use of the embodiment mentioned above according to the description to be explained.

The present invention provides the phase-matched nonreciprocal polarization-rotation waveguide device scheme satisfying the phase-matching condition between two orthogonal polarization modes of the beam traveling along the PMNPR device of semiconductor or dielectric optical waveguide with magneto-optic material film clad(s) and letting an effective polarization rotation take place. Thus, the PMNPR waveguide length can be shortened, and therefore, it can be easily integrated with other semiconductor optical waveguide devices.

The present invention provides a PMNPR device scheme of semiconductor or dielectric optical waveguide with a continuous magneto-optic film clad to solve the long device length requirement in the conventional phase-matched scheme with periodic clads of magneto- optic films and non-magnetic films, and thus allows a short device length.

The present invention provides an effect to eliminate the birefringence properties of the waveguide device by optimizing the optical waveguide structure itself.

The present invention of the PMNPR optical waveguide devices can be used to build optical isolators and optical circulators, which can also be used to compose photonic integrated circuits needed to demonstrate high-capacity optical transceiver modules in data centers and optical communications applications. It has another effect for use in optical interposers and optical interconnects to transmit high-capacity data between electronic chips, thus allowing the demonstration of next-generation semiconductors and high-performance computers.

### BRIEF DESCRIPTION OF THE DRAWINGS

FIGS. 1A-1D illustrate a phase-matched nonreciprocal polarization-rotation optical waveguide device, according to an embodiment of the present invention.

FIGS. 2A-2C illustrate a phase-matched nonreciprocal polarization-rotation optical waveguide device with magneto-optic film clad on both the upper and one side of the optical waveguides, according to an embodiment of FIG. 1A.

FIGS. 3A-3D illustrate a phase-matched nonreciprocal polarization-rotation optical waveguide device having a periodic change of its rectangular-shaped waveguide width.

FIGS. 4A-4D illustrate a phase-matched nonreciprocal polarization-rotation optical waveguide device having magneto-optic film clads on both the upper and one side of the optical waveguides, according to an embodiment of FIG. 3A.

FIGS. 5A-5D illustrate a phase-matched nonreciprocal polarization-rotation optical waveguide device using a rib-type optical waveguide.

FIGS. 6A-6D illustrate a phase-matched nonreciprocal polarization-rotation optical waveguide device with a periodic change of its width of rib-type optical waveguide.

FIGS. 7A-7D illustrate a phase-matched nonreciprocal polarization-rotation optical waveguide device having a trench within its optical waveguide.

FIGS. 8A-8D illustrate a phase-matched nonreciprocal polarization-rotation optical waveguide device having a periodic change of the optical waveguide width with a trench.

FIG. 9 is a phase-matched nonreciprocal polarization-rotation optical waveguide device having input and output boundaries of the magneto-optic film at an inclined angle to the waveguide to reduce the optical loss of the propagating signals along the optical waveguide.

FIGS. 10A-10B illustrate an optical isolator and circulator scheme using this invention's phase-matched nonreciprocal polarization-rotation optical waveguide device.

FIGS. 11A-11E illustrate a phase-matched nonreciprocal polarization-rotation optical waveguide device composed so that the nonreciprocal polarization rotation angles of TE and TM polarization modes are the same, according to another embodiment of the present invention.

### DETAILED OF THE INVENTION

Hereinafter, the accompanying drawings will describe exemplary embodiments of a phase-matched nonreciprocal polarization-rotation optical waveguide device of the present invention and an optical isolator and optical circulator device. It is noted that the same notations represent the same components in the drawings wherever they are used. Unless otherwise particular definitions are defined, all terms in this specification have common meanings that general technical people involved in this invention subject understand.

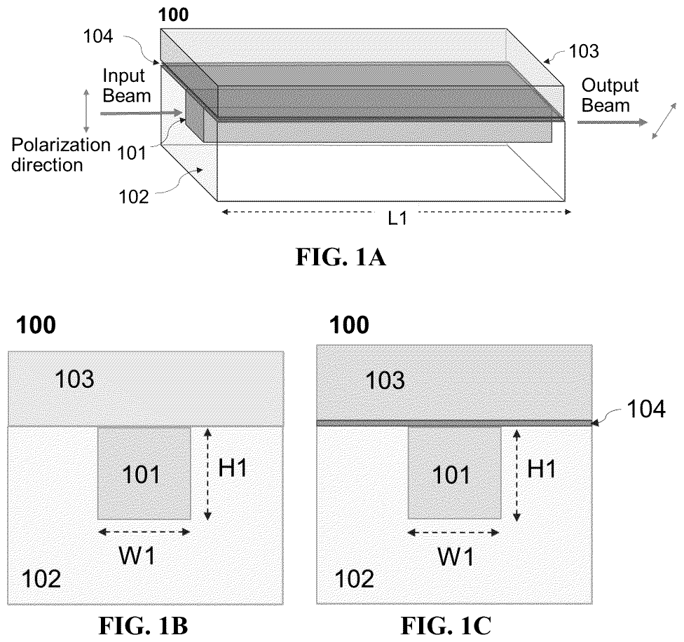

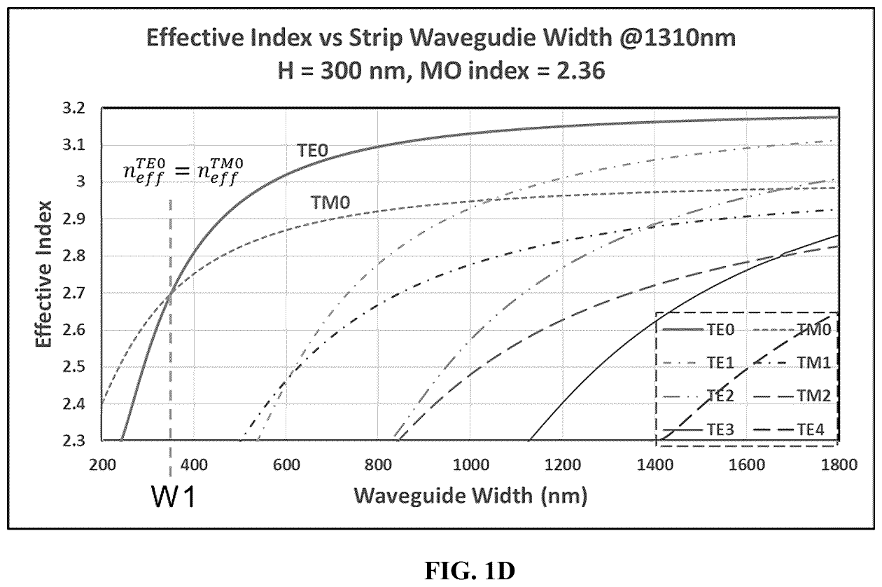

In FIGS. 1 to 11, the phase-matched nonreciprocal polarization rotation optical waveguide device 100, according to an embodiment of the present invention, is composed of an optical waveguide 101 of a relatively high refractive index along which the light signal passes through, a clad 102 surrounding the optical waveguide 101, a buffer layer 104 placed between the waveguide 101 and the magneto-optic film 103 to support crystallization processes of the magneto-optic film, and the magneto-optic film 103 of relatively lower refractive index compared to the waveguide 101 positioned at either one or two side clad(s). This optical waveguide 101 has a width satisfying the condition that the traveling light signal has the same effective refractive index of its TE and TM polarization modes.

The optical waveguide 101 can be made of one the optical materials, such as Si, SiN, SiO₂, InP, GaAs, and Ge, which has a low optical loss and is to be integrated with other optical devices.

The magneto-optic film 103 is made of an optical material with high transparency and a considerable Faraday rotation value at the wavelength in use. Examples of the magneto-optic film materials are Bi:YIG, Ce:YIG, Pr,Bi:YIG, Bi, Tb:FeGaO, Bi,Nd:Feo, Ce:TbFeO, Dy:CeFeO, and so on. When such a material is coated on a silicon surface as a magneto-optic film 103, a buffer layer 104 of YIG or MgO can be coated for tens of nanometers or thinner thickness in advance to release the lattice constant difference problem. If the magneto-optic film 103 has a sizeable remanent magnetization, it can be used without any external magnetic field. On the other hand, when the magneto-optic film 103 has a small or no remanent magnetization, a magnetic film can be coated on top of the MO film. Examples of the magnetic film are SmCo, SmCoCuFeZr, NdFeB/Nb, FeCo, and CoPt.

The crystallization process of the coated magneto-optic film 103 can performed with a thermal treatment process over the entire film or locally with a laser annealing process, especially when the MO devices are integrated with other devices.

From now on, the structure of various embodiments of the phase-matched nonreciprocal polarization-rotation optical waveguide device will be described in detail for each drawing.

FIG. 1 is a phase-matched nonreciprocal polarization-rotation optical waveguide device as described 100 using a semiconductor optical waveguide 101 with clad 102 and magneto-optic film 103, according to an embodiment of the present invention. FIG. 1(a) shows a perspective view of this polarization-rotation optical waveguide device 100. It comprises an optical waveguide 101 with a high refractive index, bottom and side clad 102 with a relatively low refractive index, and a magneto-optic film 103 on the top. In the case where the magneto-optic film 103 on the top of the semiconductor core waveguide has a poor crystallization characteristic, a buffer layer 104 can be formed in advance below the magneto-optic film 103 to improve the crystallization process, as shown in the cross-sectional structure of FIG. 1(c). The waveguide can be formed as shown in FIG. 1(b) with no buffer layer for the magneto-optic films, which can be crystallized easily without any buffer layer 104. FIGS. 1(b) and 1(c) show the cross-sectional structures of the waveguide devices without and with a buffer layer 104, respectively, depending on the crystallization characteristics of the magneto-optic film placed on the top. FIG. 1(d) shows an exemplary result of the calculated effective refractive indices for waveguide modes when the waveguide width varies at a fixed height H1 of the optical waveguide 101. In this case, the waveguide width W1, for which the effective refractive indices of the fundamental guiding modes TE0 (vertical polarization) and TM0 (horizontal polarization) are the same, is selected. The waveguide length L1 is determined to obtain the polarization-rotation angle θ depending on the magneto-optic film's Faraday rotation property F (degree/cm). The thickness H1 of the optical waveguide 101 is determined according to the refractive indices of the external clad 102 and the upper magneto-optic film 103, and the waveguide width is selected for which the same effective refractive index condition of the fundamental TE and TM modes meets when the width of the waveguide 101 is varied.

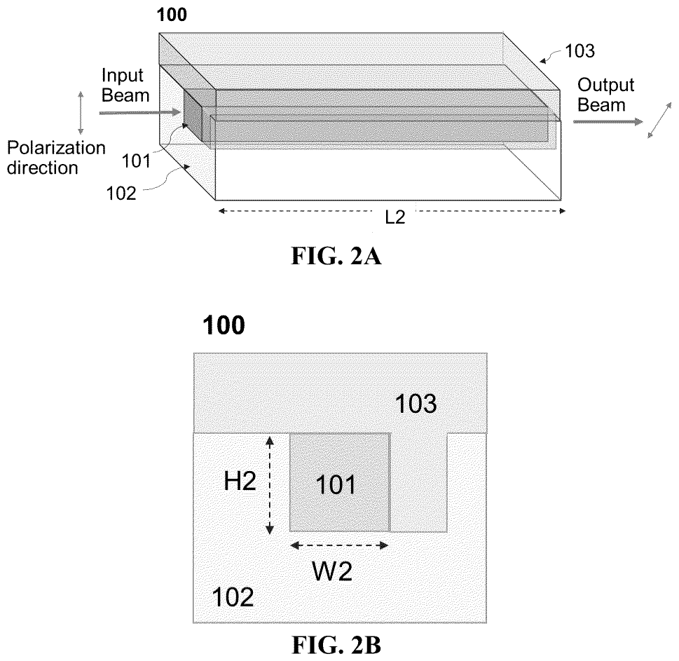

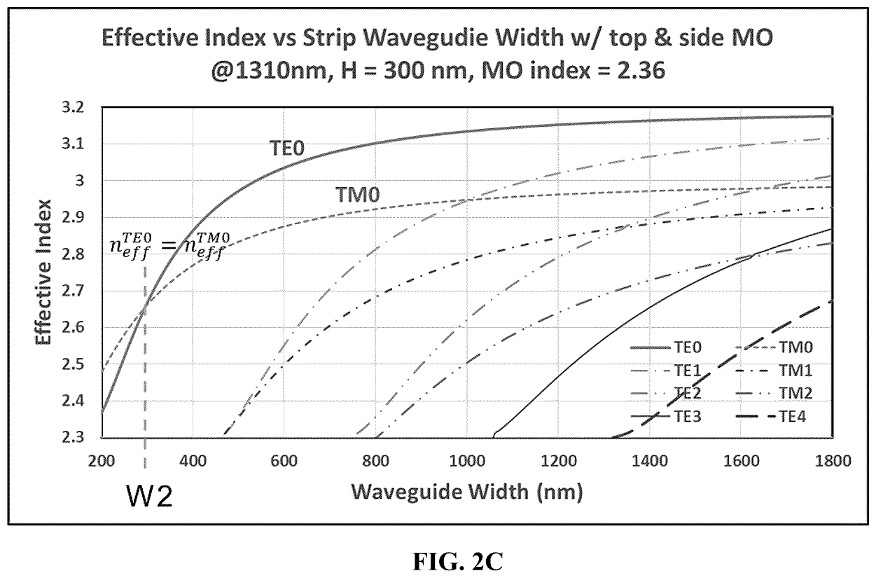

FIG. 2 is a drawing for the phase-matched nonreciprocal polarization-rotation optical waveguide device 100 using an enhanced polarization rotation of the magneto-optic effect with the magneto-optic films 103 formed both on the top and one side of the optical waveguide 101 according to a second embodiment of the present invention. FIG. 2(a) shows a perspective view of this polarization-rotation optical waveguide device 100. An optical signal entering the optical waveguide 101 suffers a polarization rotation during the passage of the waveguide length L2. FIG. 2(b) shows the cross-sectional structure of the waveguide device 100. FIG. 2(c) shows an exemplary result of the calculated effective refractive indices for waveguide modes when the waveguide width varies at a fixed height H2 of the optical waveguide 101. In this case, the waveguide width W2, for which the effective refractive indices of the fundamental guiding modes TE0 and TM0 are the same, is selected. The waveguide length L2 is determined to obtain the polarization-rotation angle θ depending on the magneto-optic film's Faraday rotation property F (degree/cm).

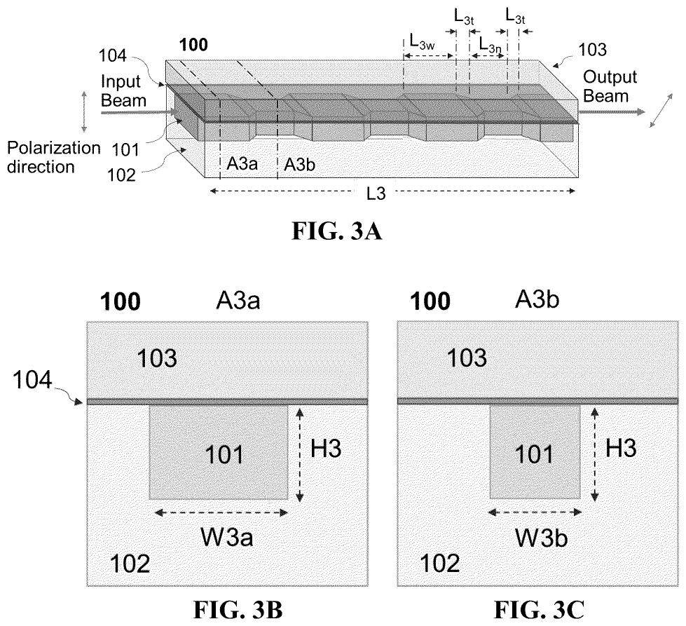

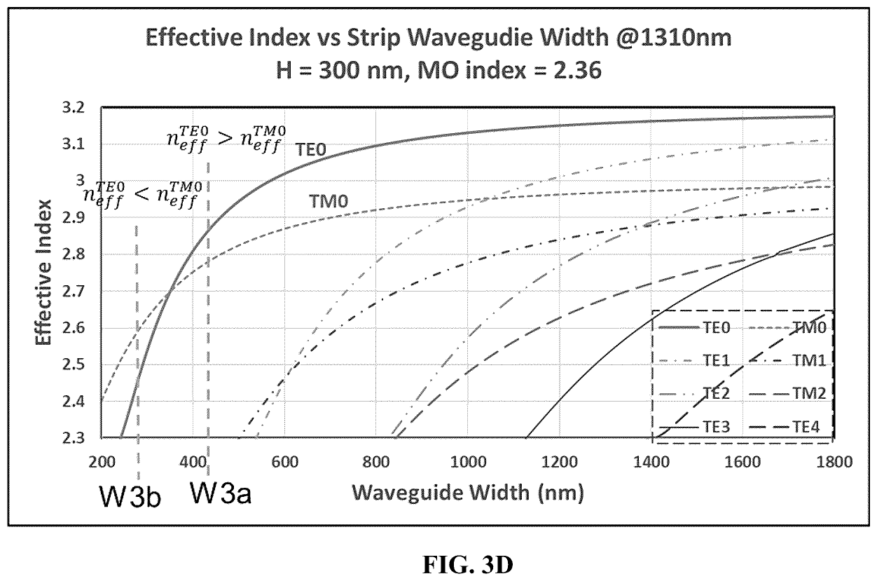

FIG. 3 is a drawing for the phase-matched nonreciprocal polarization-rotation optical waveguide device 100, according to a third embodiment of the present invention. This device has a structure of periodic arrangement of waveguides of broader and narrower waveguide widths, W3a and W3b, than the waveguide width of the same effective refractive index of the vertical and horizontal polarization mode at a fixed waveguide height H3 when the magneto-optic films 103 is used as an upper clad of the optical waveguide device. For the polarization-rotation optical waveguide device 100 of FIG. 1, although the device is designed for the waveguide width W1 having the same effect index for the vertical and horizontal polarization modes, the practical device could be fabricated to a different waveguide width due to the fabrication error. In addition, when the optical waveguide 100 has a sidewall slope, reciprocal polarization rotation occurs in addition to the non-reciprocal polarization rotation due to the magneto-optic effect. In contrast, FIG. 3 uses a device structure of periodic arrangement of constant lengths of the waveguides of wider width W3a and narrower width W3b than the width W1 and shows a phase-matched nonreciprocal polarization-rotation optical waveguide device 100 to have the same phase of the vertical and horizontal polarization modes of the traveling beam during passage through one period of the waveguides of relatively large and small effective indices for the vertical and horizontal polarization modes. This device structure is relatively insensitive to fabrication errors and satisfies the phase-matching conditions well. FIG. 3(a) shows a perspective view of this polarization-rotation optical waveguide device 100. FIGS. 3(b) and 3(c) illustrate the cross-sectional views (A3a, A3b) of the optical waveguides 101 of wide width and narrow width, respectively. FIG. 3(d) shows an exemplary result of the calculated effective refractive indices for waveguide modes when the waveguide width varies at a fixed height H3 of the optical waveguide 101. In this case, the waveguide 101's widths, W3a and W3b, for which the effective refractive indices of the fundamental guiding modes TE0 and TM0 are relatively larger and smaller compared to the other's, are selected. The waveguide length L3w of the wide width W3a of the optical waveguide 101 and the waveguide length L3n of the narrow width W3b are determined so that the phase difference between the vertical and horizontal polarization modes becomes zero. The tapered waveguide length L4t between the wide and narrow waveguides is arranged symmetrically in opposite directions to cancel out the phase shift caused by the tapers. The total length L3 of the waveguide 101 is determined to obtain the polarization-rotation angle θ depending on the Faraday-rotation property F (degree/cm) of the magneto-optic film.

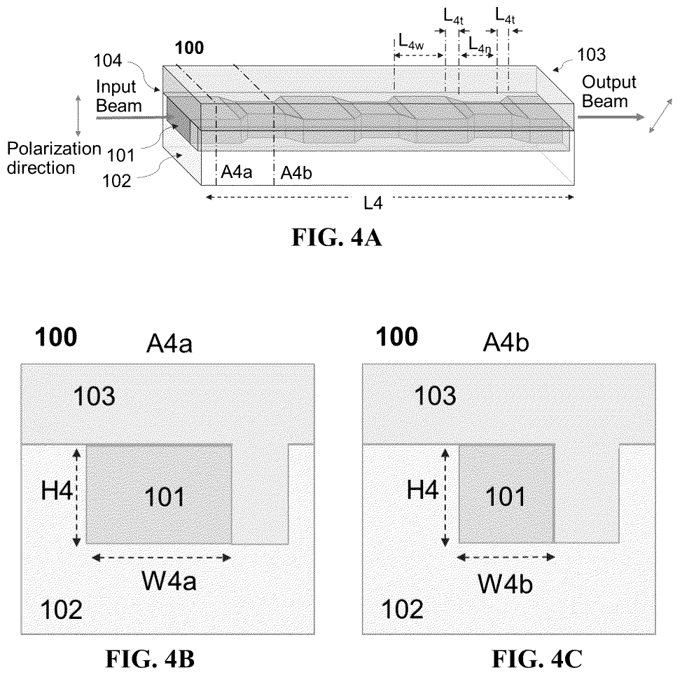

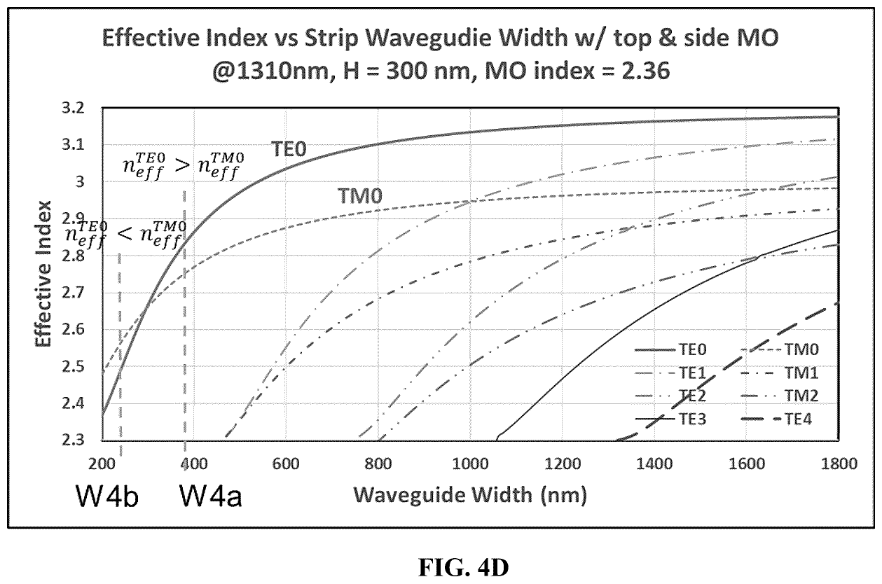

FIG. 4 is a drawing for the phase-matched nonreciprocal polarization-rotation optical waveguide device 100 with a magneto-optic film 103 on one side clad in addition to the top clad of the FIG. 3 according to another embodiment of the present invention. FIG. 4(a) shows a perspective view of this polarization-rotation optical waveguide device 100. FIGS. 4(b) and 4(c) illustrate the cross-sectional views (A4a, A4b) of the optical waveguides 101 of wide width and narrow width, respectively. FIG. 4(d) shows an exemplary result of the calculated effective refractive indices for waveguide modes when the waveguide width varies at a fixed height H4 of the optical waveguide 101. In this case, the waveguide 101's widths, W4a and W4b, for which the effective refractive indices of the fundamental guiding modes TE0 and TM0 are relatively larger and smaller compared to the other's, are selected. The length L4w of the optical waveguide 101 of the wide width W4a, the waveguide length L4n of the narrow width W4b, and the total length L4 of the waveguide 101 are determined by using the same principle discussed in FIG. 3.

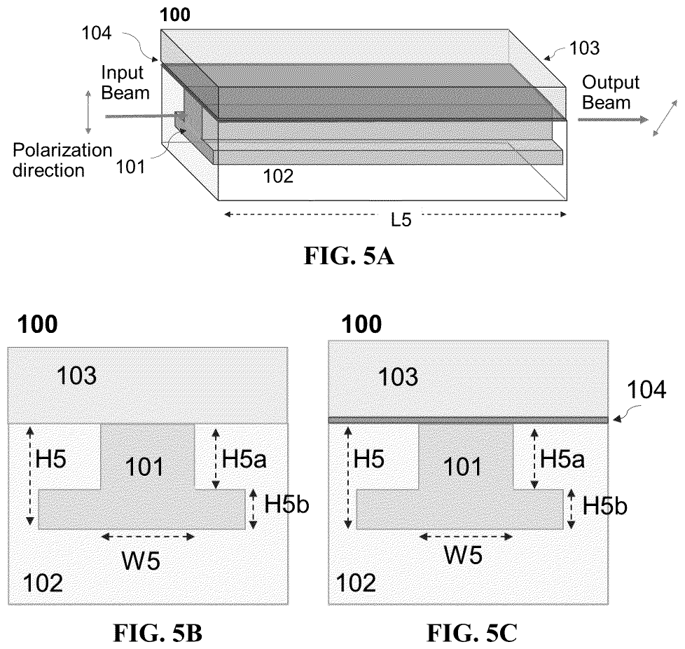

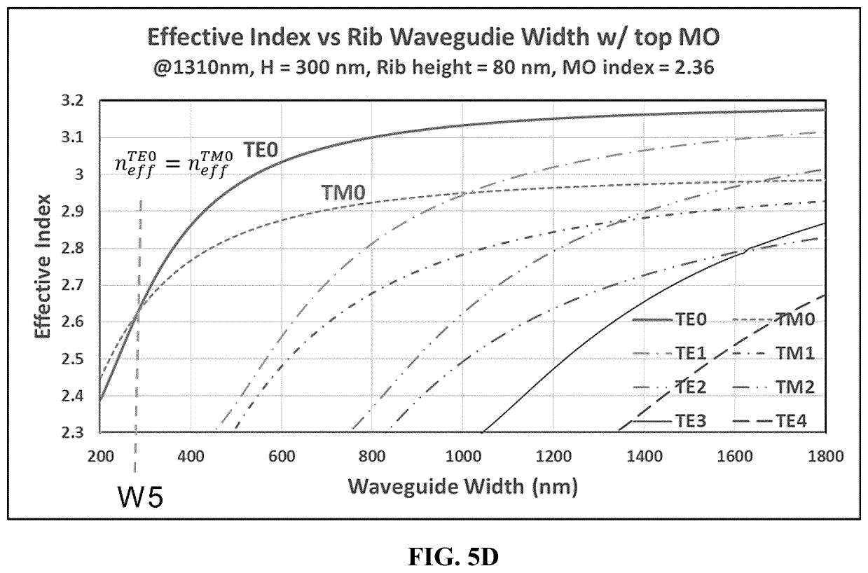

FIG. 5 is a drawing for the phase-matched nonreciprocal polarization-rotation optical waveguide device 100 using a rib-type waveguide 101 according to another embodiment of the present invention. FIG. 5(a) shows a perspective view of this polarization-rotation optical waveguide device 100. FIGS. 5(b) and 5(c) show the cross-sectional structures of the waveguide devices without and with a buffer layer 104, respectively. FIG. 5(d) shows an exemplary result of the calculated effective refractive indices for waveguide modes when the waveguide width varies at a fixed height H5 of the optical waveguide 101, the etching depth H5a, and the residual thickness (residual height). In this case, the waveguide width W5, for which the effective refractive indices of the fundamental guiding modes TE0 and TM0 are the same, is selected. The waveguide length L5 is determined to obtain the polarization-rotation angle θ depending on the magneto-optic film's Faraday-rotation property F (degree/cm). In this device structure, the selection condition for the waveguide width W5 of the optical waveguide 101 differs for various values of the etching thickness H5a.

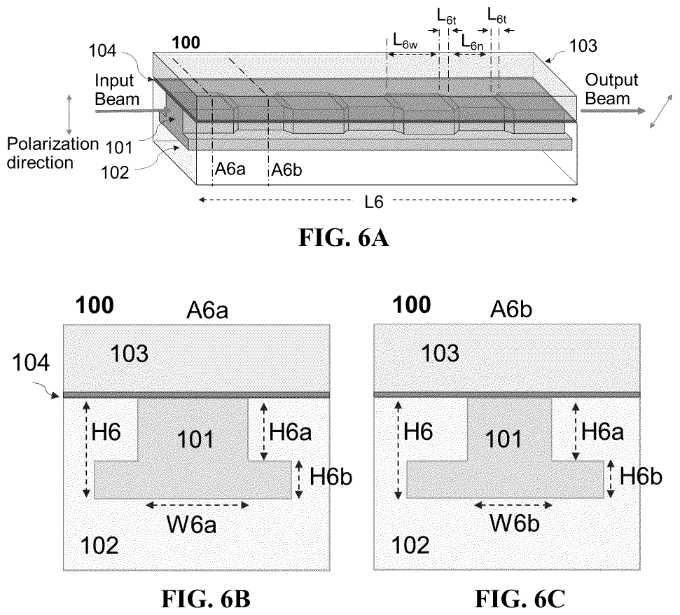

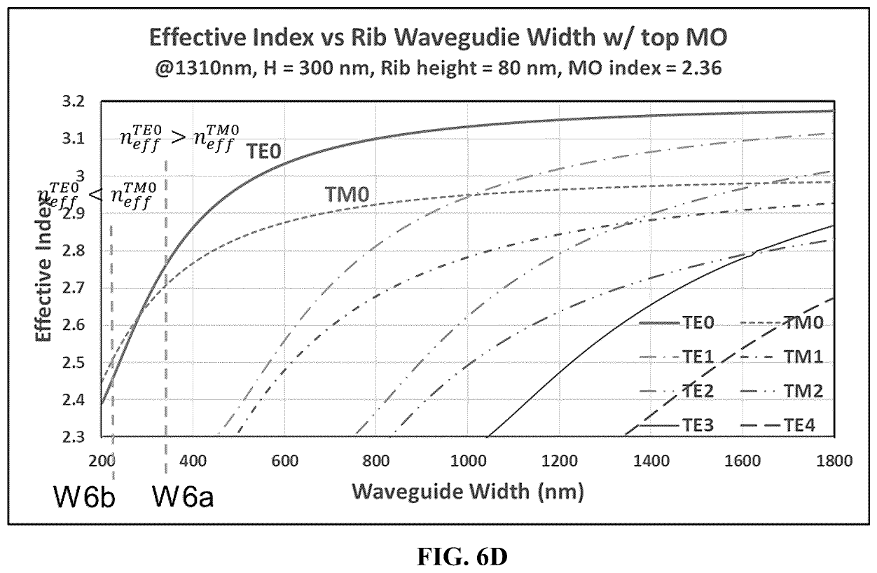

FIG. 6 is a drawing for the phase-matched nonreciprocal polarization-rotation optical waveguide device 100 using a periodic width change of a rib-type waveguide 101 according to another embodiment of the present invention. FIG. 6(a) shows the device structure of the periodic arrangement of wide optical waveguide 101 (FIG. 6(b)) and narrow optical waveguide 101 (FIG. 6(C)) compared to the optical waveguide width whose effective refractive indices for the vertical and horizontal polarization modes with a fixed height H6, etched depth H6a and residual thickness (residual height) are the same. FIGS. 6(b) and 6(c) illustrate the cross-sectional views (A6a, A6b) of the optical waveguide 101 of wide width and narrow width, respectively. FIG. 6(d) shows an exemplary result of the calculated effective refractive indices for waveguide modes when the waveguide width varies at a fixed height H6, etched depth H6a, and residual thickness of the optical waveguide 101. The waveguide widths, W6a and W6b, of the optical waveguide 101 are selected consecutively so that the fundamental guiding modes TE0 and TM0 modes have large and small effective refractive indices compared to the others. The waveguide length L6 is determined to obtain the polarization-rotation angle 0θ depending on the Faraday-rotation property F (degree/cm) of the magneto-optic film 103.

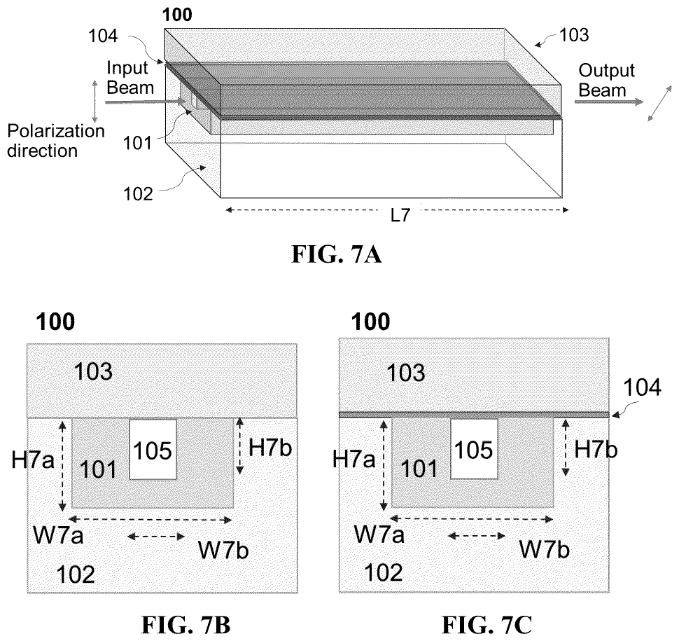

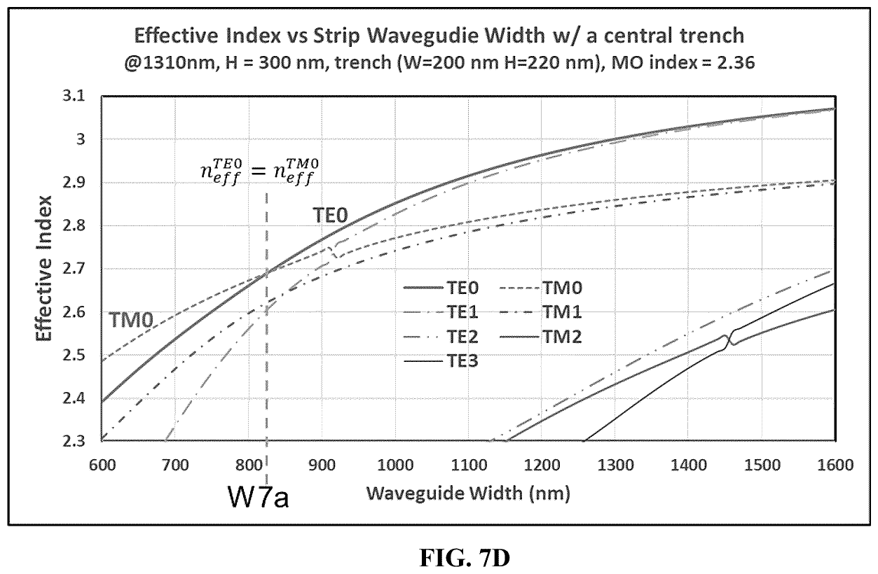

FIG. 7 is a phase-matched nonreciprocal polarization-rotation optical waveguide device 100 using a trench 105 formed in the middle of the optical waveguide 101 and filled with the same material with the clad 102 material or with another material according to another embodiment of the present invention. FIG. 7(a) shows a perspective view of this polarization-rotation optical waveguide device 100. FIGS. 7(b) and 7(c) show the cross-sectional structures of the waveguide devices without and with a buffer layer 104, respectively. FIG. 7(d) shows an exemplary result of the calculated effective refractive indices for waveguide modes when the width of the optical waveguide 101 varies at a fixed height H7a and a fixed width W7b and depth H7b of the trench. The waveguide width, W7a, for which the effective refractive indices of the fundamental guiding modes TE0 and TM0 are the same, is selected. In this scheme, the width W7a of the optical waveguide 101 satisfying the condition of the same effective index for the TE and TM polarization modes can be determined similarly even when the height H7b and width W7b of the trench are changed. The waveguide length L7 is determined to obtain the polarization-rotation angle θ depending on the Faraday-rotation property F (degree/cm) of the magneto-optic film 103.

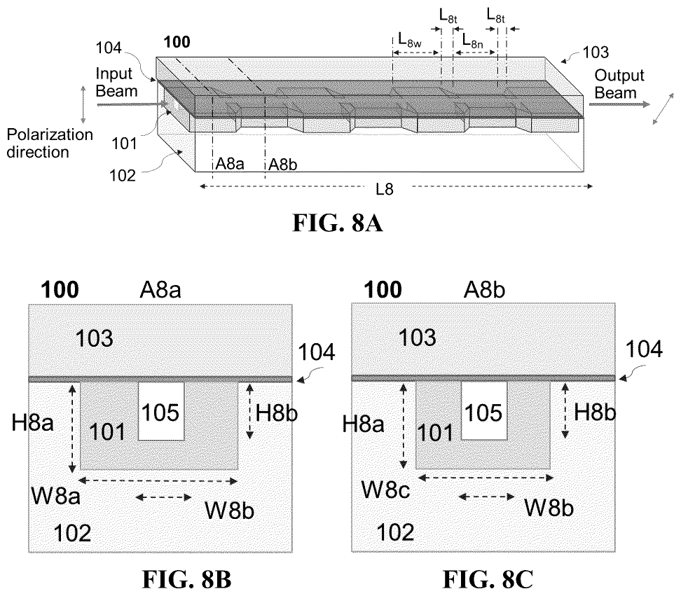

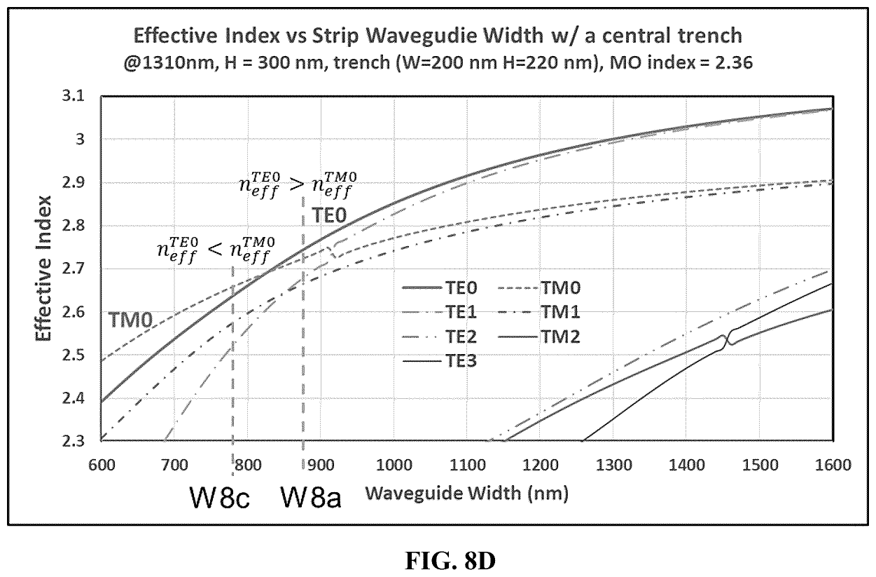

FIG. 8 is a phase-matched nonreciprocal polarization rotation optical waveguide device 100 using a periodic width change of the optical waveguide 101 with a trench 105 formed in the middle and filled with the same material with the clad 102 material or with another material according to another embodiment of the present invention. FIG. 8(a) shows a perspective view of this polarization-rotation optical waveguide device 100. FIGS. 8(b) and 8(c) show the cross-sectional structures of the optical waveguide 101 of wide and narrow width, respectively, for a fixed waveguide height H8a and the depth H8b and width W8b of the trench. FIG. 8(d) shows an exemplary result of the calculated effective refractive indices for waveguide modes when the width of the optical waveguide 101 varies at a fixed height H8a and a fixed depth H8b and width W8b of the trench. The widths, W8a and W8b, of the optical waveguide 101 are selected consecutively so that the fundamental guiding modes TE0 and TM0 modes have large and small effective refractive indices compared to the others. In this scheme, the width W8a of the optical waveguide 101 satisfying the condition of the same effective index for the TE and TM polarization modes can be determined similarly even when the height H8b and width W8b of the trench are changed. The waveguide length L8w of the wide width W8a of the optical waveguide 101, the waveguide length L8n of the narrow width W8b, and the total length L8 of the waveguide 101 are determined by using the same principle discussed in FIG. 3.

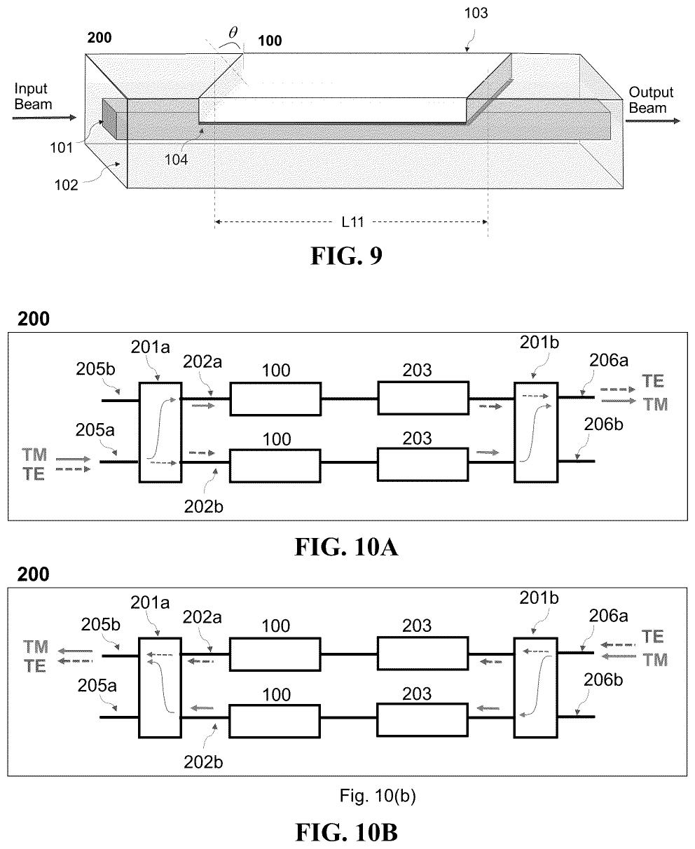

FIG. 9 is an optical waveguide scheme using the above phase-matched nonreciprocal polarization-rotation optical waveguide device 100 included in the form of a partial waveguide of length L11 within the planar optical waveguide 110 which is composed of the optical waveguide 101 of a high refractive index surrounded by a relatively low refractive index clad. The input and output boundaries of the magneto-optic film 103 and thin buffer layer 104 can be placed on the top of the optical waveguide at a constant angle θ to the perpendicular direction of the waveguide traveling axis so that the optical loss of the traveling signal is reduced.

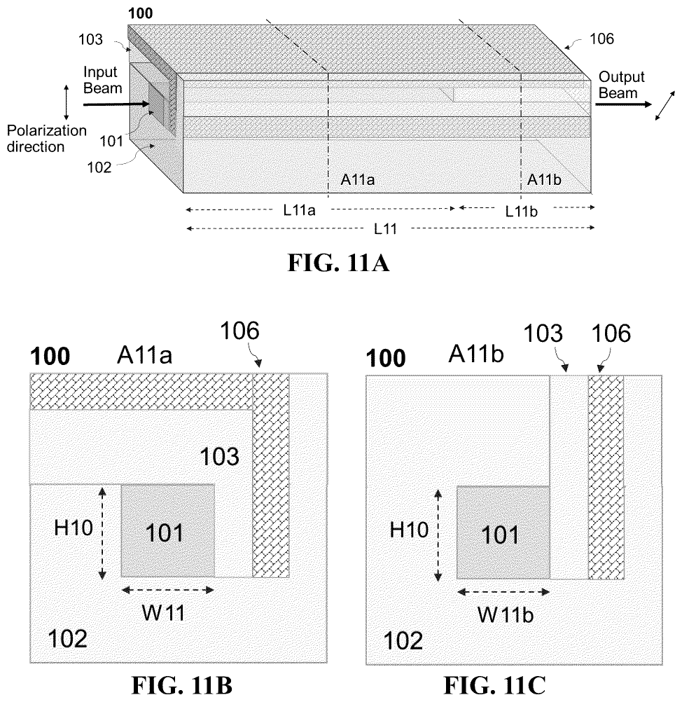

FIG. 10 is an optical isolator and circular scheme 200 using the above phase-matched nonreciprocal polarization-rotation optical waveguide device 100 of the present invention. It includes two input ports, 205a and 205b, connected to a polarization beam splitter 201a, from which polarization-separated outputs are connected to optical waveguide paths 202a and 202b. On each of the optical waveguide paths 202a and 202b, a non-reciprocal 45° polarization rotator based on the above phase-matched nonreciprocal polarization-rotation optical waveguide device 100 and a reciprocal 45° polarization rotator 203 is placed, and the paths are connected to a polarization beam splitter 201b on the opposite side. The other side of the polarization beam splitter 201b has output ports 206a and 206b. An operation example is explained as follows. An optical input signal enters the input polarization beam splitter 201a through the lower input port 205a, as shown in FIG. 10(a) and travels to the crossed output port 202a for TM mode output and to the bar output port 202b for TE mode output. Then, these two polarization modes suffer polarization mode conversion during the passage through the optical waveguide paths so that the TM mode is converted to TE mode and the TE mode is converted to TM mode. The converted TE mode during the passage through path 202a travels to the bar output port 206a of the polarization beam splitter 201b of the output side, and the converted TM mode during the passage through path 202b travels to the crossed output port 206a. Reflected optical signals returning to the output port 206a travel to the crossed output port 202b of the polarization beam splitter 201b for TM mode and to the bar output port 202a for TE mode. Each of these two polarization modes travels separate optical paths and suffers no polarization mode conversion because opposite polarization rotations occur during the passage through the reciprocal polarization rotator 203 and then the nonreciprocal polarization rotator 100. Thus, the TE mode travels to the bar port 205b of the polarization beam splitter 201a, and the TM mode passing through the lower optical path 202b travels to the crossed port 205b, which is different from the original input port. As shown in FIGS. 10(a) and 10(b), the input entering port 205a comes out through the opposite output port 206a, but the reflected beam does not return to the original input port 205a, which indicates a demonstration of the optical isolation function.t An optical beam entering the opposite output port 206a comes out through the different port 205b of the input side, which illustrates the performance of the optical circulator function.

In the optical isolator and circular scheme 200 using the phase-matched nonreciprocal polarization-rotation optical waveguide device 100 of FIG. 10, each of the TE and TM polarization modes of the input and reflected beams travel different optical paths of 202a and 202b. The orthogonal polarization mode passes in forward and backward directions for the phase-matched nonreciprocal polarization-rotation optical waveguide device 100 in each optical path. Therefore, the phase-matched nonreciprocal polarization-rotation optical waveguide device 100 must work equally for the two orthogonal polarization modes. However, the previously described phase-matched nonreciprocal polarization-rotation optical waveguide device 100 has a structure of relatively small Faraday rotation effect of the magneto-optic film 103 on the side wall compared to that of the upper clad magneto-optic film due to relatively weak magnetic field influence.

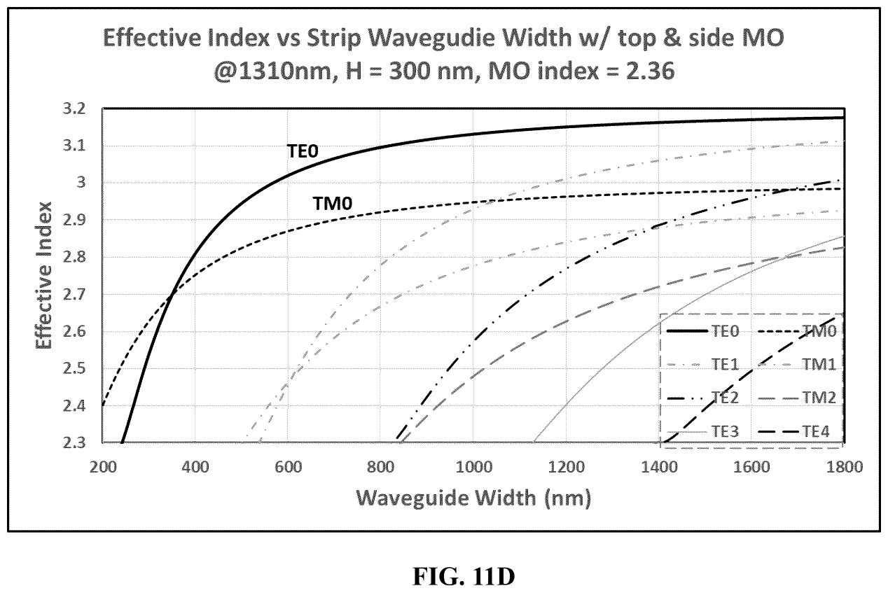

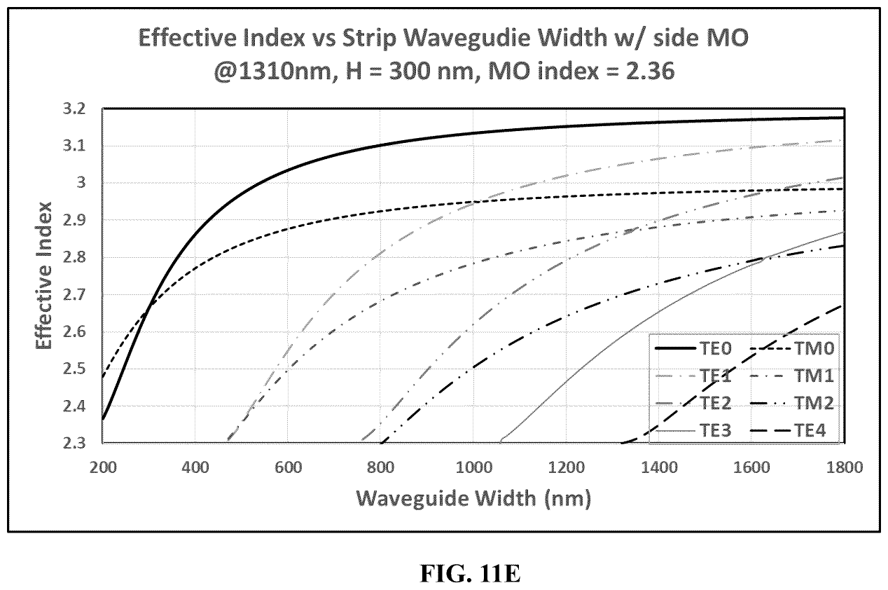

FIG. 11 is a phase-matched nonreciprocal polarization-rotation optical waveguide device 100 composed to have almost equal nonreciprocal polarization rotation for both TE and TM polarization modes by adding a length L11b of a waveguide with a magneto-optic film 103 on one side for additional the non-reciprocal polarization rotation of the TE mode to the length L11a of the polarization rotation waveguide with upper and side magneto-optic film 103 of FIG. 3 according to another embodiment of the present invention. The polarization rotation length L11b for the TE polarization mode is added to compensate for the nonreciprocal polarization rotation difference between the TE and TM modes that arose in the length L11 portion. Then, the total length becomes L11, which corresponds to their addition. FIG. 11(a) shows a perspective view of this polarization-rotation optical waveguide device 100. If the magneto-optic film 103 has a small residual magnetization, a magnetic film 106 is formed to induce an external magnetic field. FIGS. 11(b) and 11(c) show the cross-sectional structures A11a and A11b of the optical waveguide 101 with upper and side magneto-optic film 103 and with a magneto-optic film 103 on one side, respectively. If the magneto-optic film 103 has a large residual magnetization and a strong self-Faraday rotation effect, the device structure can be used without using any external magnetic field. FIG. 11(d) shows an exemplary result of the calculated effective refractive indices for waveguide modes when the width of the optical waveguide 101 varies for a fixed height of the polarization rotation portion L11a of the waveguide with upper and side magneto-optic film 103. FIG. 11(e) shows an exemplary result of the calculated effective refractive indices for waveguide modes when the width of the optical waveguide 101 varies for a fixed height of the polarization-rotation portion L11b of the waveguide with a magneto-optic film 103 on one side. If a phase-matched nonreciprocal polarization-rotation optical waveguide device 300 is composed of the optical waveguides 101 at the conditions of the same effective index for the TE and TM modes in FIG. 11(d) and FIG. 11(e), it can replace the optical waveguide device 100 of FIG. 10 to perform a perfect optical isolator and circulator for optical beams in both forward and backward directions.

In FIG. 11, a scheme to compensate for the nonreciprocal polarization-rotation difference between the TE and TM modes is described only for the optical waveguide 101, which has a straight rectangular cross-section of FIG. 2. The same principle can be applied to the phase-matched nonreciprocal polarization-rotation optical waveguide device 100 of FIG. 1 to FIG. 8.

So far, the applicants have described various embodiments of the present invention; these embodiments are only examples that implement the technical idea of the present invention. Any other embodiments, which include changes or modifications to implement the technical idea of the present invention, should be interpreted as belonging to the scope of the present invention.

What is claimed is:

1. A phase-matched nonreciprocal polarization-rotation optical waveguide device to have the phase-matched condition between TE and TM polarization modes in nonreciprocal polarization rotation processes comprising:
an optical waveguide of relatively high refractive index for optical signal transmission; cladding layers surrounding the above optical waveguide;
one or two side cladding layers of the above optical waveguide composed of magneto- optic films of relatively low refractive index;
the above optical waveguide has a width for the same effective refractive index for the fundamental TE and TM polarization modes at the wavelength of optical signals propagating along the waveguide.

2. The phase-matched nonreciprocal polarization-rotation optical waveguide device of claim 1, wherein the optical waveguide consists of a periodic arrangement of consecutive wide width and narrow width waveguides compared to the waveguide width of the same effective index of the TE and TM polarization modes at the propagating optical signal wavelength to satisfy the overall phase matching condition between the two polarization modes.

3. The phase-matched nonreciprocal polarization-rotation optical waveguide device of claim 1, wherein the optical waveguide is composed of a strip waveguide(s) having a constant rectangular-shaped cross-section(s).

4. The phase-matched nonreciprocal polarization-rotation optical waveguide device of claim 1, wherein the optical waveguide is composed of rib waveguide(s) having a wider width in the lower region and a narrow width in the upper area.

5. The phase-matched nonreciprocal polarization-rotation optical waveguide device of claim 1, wherein the optical waveguide has a cross-section with an internal trench.

6. The phase-matched nonreciprocal polarization-rotation optical waveguide device of claim 1, wherein a buffer layer is included between the optical waveguide and the magneto-optic film to enhance the crystallization process of the MO film depending on the crystallization properties of the MO film.

7. The phase-matched nonreciprocal polarization-rotation optical waveguide device of claim 1, wherein the phase-matched nonreciprocal polarization-rotation optical waveguide device is included as a part of a planar optical waveguide device which consists of optical waveguide part of high refractive index surrounded by clads of relatively low refractive index;
the boundary of the magneto-optic film and thin buffer layer of the above phase-matched nonreciprocal polarization-rotation optical waveguide device being placed at a titled angle with respect to the beam propagating axis of the optical waveguide to reduce the loss of the optical signals propagating along the optical waveguide.

8. An integrated optical isolator and optical circulator devices comprising:
a pair of polarization beam splitters having two input and output ports on both sides;
a phase-matched nonreciprocal polarization-rotation optical waveguide device of this invention having a length of 45-degree polarization rotation;
a reciprocal polarization-rotation optical waveguide device to have a 45-degree polarization rotation;
two optical waveguide paths connecting the above two polarization beam splitters;
the above nonreciprocal polarization-rotation optical waveguide device and reciprocal polarization-rotation optical waveguide device are placed on each of the above two optical paths;
an input optical signal entering one input port of the polarization beam splitter placed on the input side outputs through the output port of the polarization beam splitter placed on the other side;
reflected optical signals from the above output port of the polarization beam splitter travel in a backward direction but come out from the other port of the polarization beam splitter on the original input side.
